(19) United States
(12) Patent Application Publication
(10) Pub. No.: US 2024/0397866 A1
(43) Pub. Date: Dec. 5, 2024

(54) HEADER FLOATATION PREDICTIVE GROUND FOLLOWING

(71) Applicant: CNH Industrial America LLC, New Holland, PA (US)

(72) Inventors: Glenn Bird, Leola, PA (US); Kevin Hanson, Akron, PA (US)

(73) Assignee: CNH Industrial America LLC, New Holland, PA (US)

(21) Appl. No.: 18/204,015

(22) Filed: May 31, 2023

(51) Int. Cl. A01D 41/14

(52) U.S. Cl. CPC A01D 41/145; A01D 41/141

(57) ABSTRACT

A predictive algorithm for ground conditions using header (108) position feedback to support header (108) floatation control. A velocity, an acceleration, and a change in acceleration associated with a change in header (108) position due to ground contour changes are calculated. Using position feedback, the header floatation control system (400) can predict ground contours to increase floatation ground force when cresting hills and decrease floatation ground force when approaching hills.

### BACKGROUND OF THE INVENTION

Various types of agricultural vehicles use headers to process crop materials. For example, windrowers (also known as swathers) are used to cut crop material and form it into windrows (a cut row or material) that is later processed, typically after drying, by other equipment. Similarly, combine harvesters use headers to process crop materials, which are conveyed into a crop processing system located on the chassis of the vehicle. In either case, it is often desirable to movably mount the header to the chassis of the vehicle to allow height adjustment and/or tilt adjustment.

It is also often desirable to mount the header such that it can move to follow or “float” over undulating terrain. Similar capability is often desirable in multi-segment headers to allow an articulated portion of the header to adjust or float relative to an adjacent part of the header. Header floatation refers to support by the chassis of a majority of the header weight, but not all, in order to let the vehicle effectively push the header forward in contact with the ground, with a small amount of predetermined force acting between the header and the ground.

A typical self-propelled windrower has a header that is movably mounted to the vehicle chassis by hydraulic actuators. The hydraulic actuators comprise piston and cylinder assemblies that use hydraulic fluid to move the piston relative to the cylinder. The position of the header is controlled by changing the volume of fluid in the cylinder. Float is provided by including an accumulator in the hydraulic circuit. A typical accumulator is a reservoir that is fluidly connected to the hydraulic circuit, and contains a volume of pressurized gas. In use, as the header moves over undulating terrain, the gas can expand and contract to provide a spring-like resilience to the hydraulic circuit. Thus, the header is effectively suspended on an air spring.

It will be appreciated from the foregoing that the gas pressure dictates the spring force, and therefore controls the amount of force required to allow the header to float. The spring force can be adjusted by varying the state of a pressure reducing valve connected to the accumulator. For example, in one known system, a pressure reducing valve (“PRV”) is used to control the pressure. This device operates by using an electric current to set the PRV operating state. The operator can adjust the current to the PRV using a toggle switch or other controls.

Such systems are functional, but can suffer from various problems that cause the actual floatation force to vary significantly for a given current setting. For example, variations in hydraulic oil temperature, hysteresis in the PRV, and changes in operating friction throughout the system, can all change the actual floatation force provided by the accumulator without any change to the input current to the PRV. Similar problems occur when the header changes weight during operation. This can happen by accumulating crop material and soil to increase in weight. Similarly, the weight of the header can reduce after initial calibration if crop material or soil on the header during calibration fall off or dry out during operation. Thus, an experienced operator must occasionally adjust the signal to the PRV to maintain the desired floatation force.

An example of a system for controlling the header position using pressurized hydraulic fluid is provided in U.S. Pat. No. 5,633,452, which is incorporated herein by reference. In this example, the header height is established by setting a pressure in hydraulic header lift cylinders, and float is provided by providing an accumulator in the hydraulic circuit. A pressure sensor is used to determine if the hydraulic pressure in the circuit drops below a minimum safe value, and automatically raises the pressure when this happens. This system relies on sensing the hydraulic pressure of the hydraulic circuit, which can lead to problems. For example, friction in the hydraulic cylinders (so-called “stiction”), as well as at other locations such as pivots, can cause force reactions that make the hydraulic pressure of the fluid inaccurate as a measure of the actual header height setting. For example, during efforts to lift the header, a sticking hydraulic cylinder can generate high hydraulic pressure, without a corresponding increase in header height. U.S. Publication No. 2022/0053693 A1, PCT Publication No. WO2022/046769 A1, U.S. Pat. No. 7,168,226, and U.S. Publication No. 2006/0254239 also show systems for controlling a header, and these references are incorporated herein by reference.

Changing ground conditions can cause larger than desired ground forces between the header and ground when, for example, approaching an incline from level ground or when approaching level ground from a decline. In such changing ground conditions, as the vehicle approaches the transition from level to incline or from decline to level, the ground will force the header up before the front wheels of the vehicle reach the transition, inducing a larger contact force between the header and the ground. This can cause excess dirt and mud to build up in the header, further increasing header weight and causing premature skid shoe and knife wear.

At the same time, header contact with the ground can be lost when, for example, cresting a hill or an incline, or when starting a decline from level ground. In such changing ground conditions, the header may lose contact with the ground until the front wheels of the reach the transition, which can cause missed crop until the header resumes contact with the ground. Failure to maintain proper header floatation over changing ground conditions requires the operator to continually reset header floatation and generally operate the header with more manual control, as well as to replace worn ground contact components more frequently. Prior attempts to compensate for poor floatation control have included introducing better mechanical angles and using larger skid shoes to distribute larger ground forces over a wider area on the ground.

The inventors have determined that the state of the art of header floatation system can still be improved.

This description of the background is provided to assist with an understanding of the following explanations of exemplary embodiments, and is not an admission that any or all of this background information is necessarily prior art.

### SUMMARY OF THE INVENTION

In one exemplary aspect, a method for operating a header float control system of an agricultural vehicle having a header movably mounted to a chassis by an actuator is provided. The method includes: setting a desired ground reaction force between the header and a ground surface located below the header, wherein the header is in contact with the ground surface; detecting a change in a position of the header relative to the chassis caused by a change in a contour of the ground in contact with the header; calculating a velocity, an acceleration, and a change in the acceleration for the change in the position of the header relative to the chassis; and wherein upon calculating that the acceleration is zero and the change in the acceleration is greater than zero, or wherein upon calculating that the acceleration is zero and the change in the acceleration is less than zero, adjusting a lift pressure of the actuator in proportion to the change in the acceleration for the position change of the header relative to the chassis to maintain the desired ground reaction force.

In some exemplary aspects, setting the desired ground reaction force comprises receiving a selection of an adjustable value for the desired ground reaction force.

In some exemplary aspects, detecting the change in the position of the header relative to the chassis comprises detecting a change in the position of the actuator.

In some exemplary aspects, the actuator comprises a hydraulic actuator, and adjusting a lift pressure of the actuator in proportion to the change in the acceleration for the position change of the header relative to the chassis to maintain the desired ground reaction force comprises adjusting an operating pressure of the hydraulic actuator.

In some exemplary aspects, adjusting the operating pressure of the hydraulic actuator comprises changing an output pressure of a pressure reducing valve operatively connected to the hydraulic actuator.

In some exemplary aspects, wherein upon calculating that the acceleration is zero and the change in the acceleration is greater than zero, the operating pressure of the hydraulic actuator is increased to maintain the desired ground reaction force.

In some exemplary aspects, wherein upon calculating that the acceleration is zero and the change in the acceleration is less than zero, the operating pressure of the hydraulic actuator is decreased to maintain the desired ground reaction force.

In some exemplary aspects, the velocity is calculated as a first derivative of the change in position of the header relative to the chassis, the acceleration is calculated as a second derivative of the change in position of the header relative to the chassis, and the change in acceleration is calculated as a third derivative of the change in position of the header relative to the chassis.

In another exemplary aspect, there is provided an agricultural vehicle having a chassis, a header movably mounted to the chassis, an actuator configured to move the header relative to the chassis, one or more support members extending between the header and the ground surface for contacting the ground surface, and a control system operatively connected to the actuator. The control system is configured to: set a ground reaction force between the header and a ground surface located below the header, wherein the header is in contact with the ground surface; detect a change in a position of the header relative to the chassis caused by a change in a contour of the ground in contact with the header; calculate a velocity, an acceleration, and a change in the acceleration associated with the change in the position of the header relative to the chassis; and wherein upon calculating that the acceleration is zero and the change in the acceleration is greater than zero, or wherein upon calculating that the acceleration is zero and the change in the acceleration is less than zero, adjust a lift pressure of the actuator in proportion to the change in acceleration for the position change of the header relative to the chassis to maintain the desired ground reaction force.

In some exemplary aspects, the control system comprises a user interface configured to receive a selection of an adjustable value for the desired ground reaction force.

In some exemplary aspects, the actuator comprises a hydraulic actuator, and the control system is configured to operate the hydraulic actuator to maintain the desired ground reaction force by adjusting an operating pressure of the hydraulic actuator.

In some exemplary aspects, the control system is operatively connected to a pressure reducing valve that is configured to adjust the operating pressure of the hydraulic actuator.

In some exemplary aspects, the one or more support members each comprise a skid shoe pivotally mounted to the header.

### BRIEF DESCRIPTION OF THE DRAWINGS

Embodiments of inventions will now be described, strictly by way of example, with reference to the accompanying drawings, in which:

FIG. 1 is a side schematic view of an agricultural windrower configured for use with a header float control system.

FIG. 2 is an isometric bottom view of an exemplary header.

FIG. 3 is a cutaway isometric to view of portions of the header of FIG. 1.

FIG. 4 is a schematic illustration of an exemplary header float control system.

FIG. 5 is a flow chart illustrating an exemplary method for operating a header float control system.

FIG. 6 is a schematic illustration of a hydraulic system for controlling a header.

FIG. 7 is a schematic illustration of the hydraulic system of FIG. 6, shown in a different valve configuration.

FIG. 8 is a front schematic view of an agricultural vehicle configured for use with a header wing section float control system.

FIG. 9 is a side schematic view of an agricultural windrower configured for use with a header subframe float control system.

In the figures, like reference numerals refer to the same or similar elements.

### DETAILED DESCRIPTION OF THE INVENTION

Embodiments described herein provide a method of operating a header float system of an agricultural vehicle having a header movably mounted to a chassis by an actuator system to maintain a constant, predetermined ground reaction force between a header component and the underlying ground during operation of the header. Embodiments are shown in use with windrower headers, but other embodiments may be used with other mechanisms that contact the ground.

The terms “crop” and “crop material” are used to describe any mixture of grain, seeds, straw, tailings, and the like. “Grain” or “seeds” refer to that part of the crop material which is threshed and separated from the discardable part of the crop material (e.g., straw and tailings), and includes grain in aggregate form such as an ear of corn. The portion of the crop material that generally is discarded or not used for food or growing purposes may be referred to as non-grain crop material, material other than grain (MOG) or straw.

Also, the terms “forward,” “rearward,” “left,” and “right”, when used in connection with the agricultural harvester (e.g. combine) and/or components thereof are usually determined with reference to the direction of forward operative travel of the combine, but again, they should not be construed as limiting. The terms “longitudinal” and “transverse” are determined with reference to the fore-and-aft direction of the agricultural combine and are equally not to be construed as limiting.

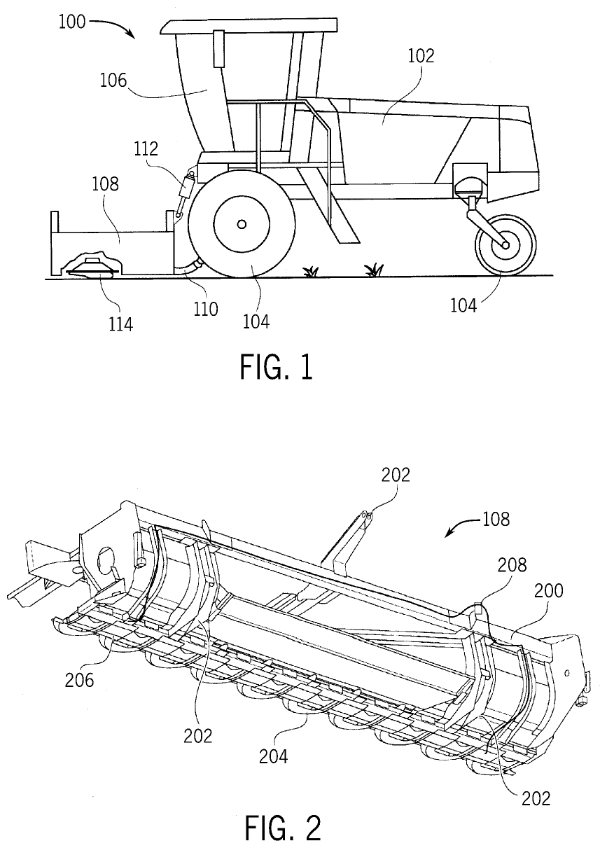

FIG. 1 shows an example of an agricultural vehicle 100 in the form of a self-propelled windrower. The vehicle 100 has a chassis 102 that is supported for movement on the ground by wheels 104 or the like, and one or more motors (not shown) are provided to power the wheels 104 and other systems. The vehicle 100 may have an operator's cab 106, and other features typical of a self-propelled windrower. A header 108 is movably mounted to the chassis 102, such as by being mounted on pivoting swing arms 110, four-bar linkages, linear slides, or the like. The header 108 includes one or more operating components, such as disc or sickle head cutters 114, that process the crop materials.

One or more actuators 112 are provided to control the position of the header 108 relative to the chassis 102. The actuators 112 typically comprise hydraulic actuators, such as telescoping piston/cylinder assemblies, but other actuators may be used (e.g., pneumatic or electric actuators). Actuators 112 may further comprise one or more sensors (not shown) for determining the position of the actuator 112, or more specifically, the position of the actuator piston in the actuator cylinder. The actuator 112 position sensor may comprise a linear potentiometer, a rotary potentiometer or encoder (since the header 108 is pivotably coupled to the chassis 102), pressure sensors on both sides of the cylinder, or any other apparatus or device known to those of skill capable of sensing a position in an actuator device and enabling a signal indicating the position to be received by a control system 400.

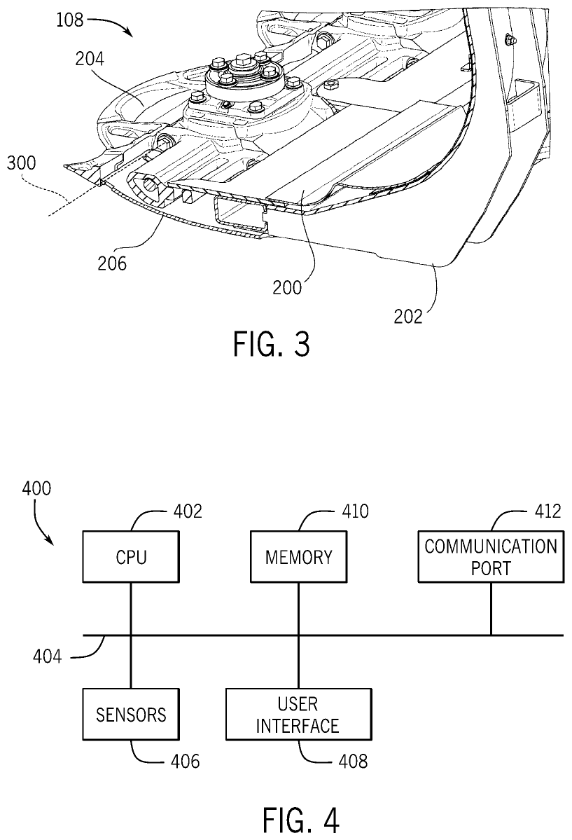

FIGS. 2 and 3 show an exemplary header 108 in more detail. The header 108 has a frame 200 having a plurality of mounting points 202 to which the actuator(s) 112, swing arms 110, or other suspension components are attached. Mounting points 202, swing arms 110, or other header 108 suspension components also may comprise one or more sensors (not shown) for determining the position of the mounting points 202, swing arms 110, or other suspension components mounting the header 108 to the chassis 102. The header 108 also includes operating components, such as crop cutters 114 (see FIG. 1), and associated parts such as rock guards 204, which typically are arrayed along the leading edge of the header frame 200.

Header support members 206, such as skid shoes (shown) or wheels, are arranged along the bottom of the header frame 200. The support members 206 may be mounted to the frame 200 by direct bolted connection or by pivots or the like. For example, each support member 206 may be pivotally mounted to rotate or flex about a respective pivot axis 300. The pivot axes 300 of the support members 206 may be co-linear or offset from each other.

In some cases, at least one support member 206 is provided at each side of a lateral centerline of the header 108, to provide support at each end of the header 108. In some cases, however, such as when the header 108 is a wing section attached to a center section, a single support member 206 may be used. An example of such an embodiment is discussed below.

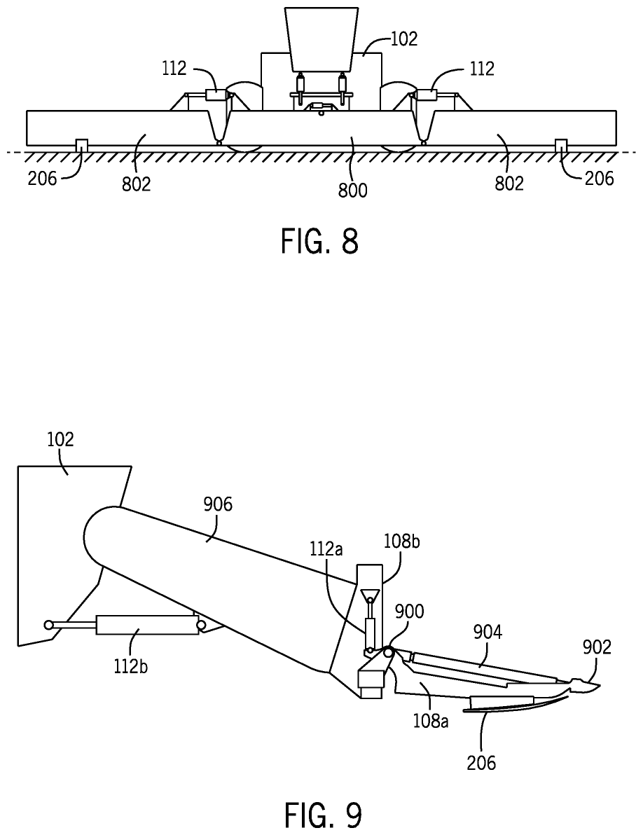

The support members 206 are positioned between the underlying ground surface and the remainder of the header 108 or the suspended portions thereof (see, e.g., the embodiments of FIGS. 8 and 9), and thus collectively carry the total weight of the header 108 or the suspended portion of the header 108 that is being supported by the ground at any given time. The remainder of the header 108 weight will be supported by the vehicle chassis 102 by way of the actuators 112 and other header 108 suspension components.

The position sensors for the header actuator 112 and header suspension components (not shown) may be electrically connected to a wiring harness for providing power to and return signals from and position sensors. Other embodiments may use battery-powered systems to operate the position sensors and send wireless signals of the position sensors' data output. The header 108 also may include an electrical terminal 208 that can be connected to an electrical control system 400, such as discussed below.

FIG. 4 is a block diagram of exemplary hardware and computing equipment that may be used as a control system 400 to control the float characteristics of the header 108. The control system 400 includes a central processing unit (CPU) 402, which is responsible for performing calculations and logic operations required to execute one or more computer programs or operations. The CPU 402 is connected via a data transmission bus 404, to sensors 406 (e.g., position sensors on actuators 112, mounting points 202, swing arms 110, pivots, or other header 108 suspension components), a user interface 408, and a memory 410. The user interface 408 may comprise any suitable device for providing user input to or output from the control system 400, such as toggle switches, dials, digital switches, touchscreen displays, and the like. The control system 400 also has a communication port 412 that may be operatively connected (wired or wirelessly) to the header's electrical terminal 208. One or more analog to digital conversion circuits may be provided to convert analog data from the sensors 406 to an appropriate digital signal for processing by the CPU 402, and signal conditioning circuits may be used to filter or perform other functions on the raw data, as known in the art.

The CPU 402, data transmission bus 404 and memory 410 may comprise any suitable computing device, such as an INTEL ATOM E3826 1.46 GHZ Dual Core CPU or the like, being coupled to DDR3L 1066/1333 MHZ SO-DIMM Socket SDRAM having a 4 GB memory capacity or other non-transitory memory (e.g., compact disk, digital disk, solid state drive, flash memory, memory card, USB drive, optical disc storage, etc.). The CPU 402 also may comprise a circuit on a chip, microprocessor, or other suitable computing device. The selection of an appropriate processing system and memory is a matter of routine practice and need not be discussed in greater detail herein. The control system 400 may be integrated into an existing vehicle control system, added as a new component, or be a self-contained system.

It is to be understood that operational steps performed by the control system 400 may be performed by the controller upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller described herein is implemented in software code or instructions which are tangibly stored on a tangible computer readable medium. Upon loading and executing such software code or instructions by the controller, the controller may perform any of the functionality of the controller described herein, including any steps of the methods described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

The inventors have determined that the float performance of a header 108 can be enhanced by using position changes of the header 108 relative to the chassis 102 to automatically adjust for changing operating conditions, such as changes the contour of the ground in contact with the header 108. By using software and position feedback of the header 108, the machine can predict ground contours to increase floatation ground force when cresting hills and decrease floatation ground force when approaching ditches on the other side of hills. This can be achieved by using the change in direction of acceleration of the header 108, or the inflection points of the data from the header 108 position sensors. This shift in the direction of acceleration will be an indication that the hill is starting to end as the header 108 continues to move upward, but at a slower pace, which will change the pressure to the header 108 allowing for a larger ground force in anticipation of cresting a hill. On the way back down, sensing a decrease in acceleration in the downward direction will indicate a lightening of ground force is required to now carve into the round at the bottom side of the hill.

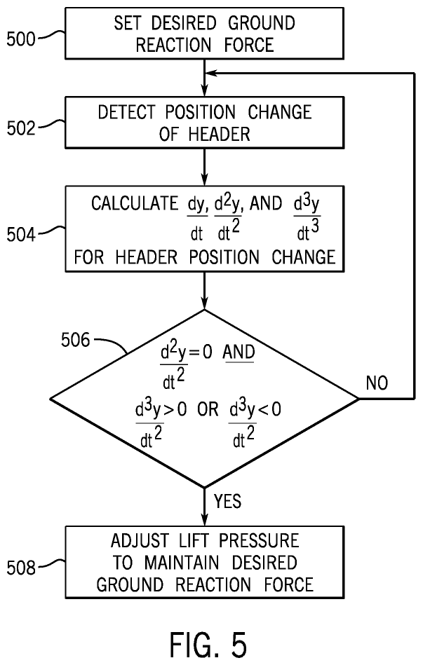

FIG. 5 illustrates an exemplary method for operating a header control system 400 to adjust the float characteristics of a header 108 based on measurements obtained by the header actuator 112 position sensors and/or the header 108 suspension component positions sensors. The method includes the following parts: 500 setting a desired ground reaction force between the header 108 and a ground surface located below the header 108, wherein the header 108 is in contact with the ground surface at the target ground reaction force; 502 detecting a change in the position of the header 108 relative to the chassis 102; 504 calculating a velocity, an acceleration, and a change in the acceleration for the change in the position of the header 108 relative to the chassis 102; and, wherein upon calculating in step 506 that the acceleration is zero and the change in the acceleration is greater than zero, or wherein upon calculating that the acceleration is zero and the change in the acceleration is less than zero, 508 adjusting the lift pressure of the header actuator 112 to maintain the desired ground reaction force.

The desired ground reaction force is the desired amount of force exerted between the header 108 (or the suspended portion, such as a wing section or subassembly, of the header 108) and the ground. This value may be a single value representing the total header weight (e.g., a total of x pounds force among all of the support members 206), or it may be divided into target ground reaction forces at multiple locations along the header 108 (e.g., x/2 pounds force at each of two support members 206). Dividing the target value into multiple forces at different locations may have the benefit of helping to ensure that the weight of the header 108 is not concentrated at a single location. Dividing the target value into multiple forces also can be used to perform separate control feedback loops at different actuators 112 associated with different support members 206. The target ground reaction force also may vary depending on the particular support member 206, such as when certain components and their associated support members 206 are desired to carry more or less weight. The target ground reaction force also may be selected based on other factors, such as the position of the header 108 or header 108 subassembly relative to the vehicle chassis 102 or the rest of the header 108. For example, the target ground force might vary depending on the position of flex arms holding operating components (e.g., higher force allowed or desired at higher vertical elevations, or vice-versa). Such values can be set according to predetermined equations or using lookup tables, or modified by manual user adjustment. Other alternatives and variations will be apparent to persons of ordinary skill in the art in view of the present disclosure.

Determining a desired ground reaction force 500 can be accomplished in various ways. The control system 400 may attempt to detect and identify the header 108 by querying the header 108 electronics via the header's electrical terminal 208 or other communication path (e.g., wireless) with the header 108. Such query may comprise a signal sent to the header 108 to determine properties of the header 108 (e.g., a particular number and/or type of support members 206 indicative of a distinct type of header), or a signal sent to a processor or circuit in the header 108 that is configured to return a header identification code or signal. The query also may be sent to other operating systems of the vehicle 100, which may be programmed to have the identity of the header 108. The identity of the header 108 may be, for example, an indicator of a particular class of headers (e.g., windrower headers, harvester headers), type of header (e.g., windrower headers with a particular blade arrangement), or it may be a unique identifier of an individual header. The identity of the header 108 also may indicate other variables, such as the particular size or width of the header. This may be useful to determine how many support members 206 will be part of the control system 400, knowing an area over which the load is distributed for determining average ground pressure, and so on.

If the control system 400 in step 500 is able to identify the header 108, it then obtains a predetermined desired ground reaction force that is associated with the particular type of header 108. For example, the header's manufacturer may recommend operating a header having a particular construction at a certain default desired ground reaction force. Upon identifying that the header 108 is one of that particular type, the control system 400 can then automatically set the ground reaction force as the predetermined desired ground force value.

The control system 400 in step 500 also may be configured to allow the operator to adjust the predetermined desired ground reaction force, based on operating conditions or other factors. Thus, the control system 400 can update the desired ground reaction force if an operator adjustment is received (e.g., add or subtract a user-selected adjustment amount value, or replace the total value with the user-selected total value).

The control system 400 in step 500 may also use a default value, or receive a user-selected adjustable value of the desired ground reaction force from the user interface 408.

In step 502, the control system 400 detects a change in the position of the header 108 relative to the chassis 102 caused by a change in a contour of the ground in contact with the header as the vehicle 100 moves over the ground.

As previously described, in a preferred embodiment, one or more actuators 112 are provided to control the position of the header 108 relative to the chassis 102. The actuators 112 typically comprise hydraulic actuators, such as telescoping piston/cylinder assemblies, but other actuators may be used (e.g., pneumatic or electric actuators). In a preferred embodiment, actuators 112 further comprise one or more sensors (not shown) for determining the position of the actuator 112, or more specifically, in the case of a hydraulic actuator, the position of the actuator piston in the actuator cylinder. The actuator position sensor may comprise a linear potentiometer, a rotary potentiometer or encoder (since the header 108 is pivotably coupled to the chassis 102), pressure sensors on both sides of the cylinder, or any other apparatus or device known to those of skill capable of sensing a position in an actuator device and enabling a signal indicating the position to be received by a control system. The header 108 has a frame 200 having a plurality of mounting points 202 to which the actuator(s) 112, swing arms 110, or other suspension components are attached. Mounting points 202, swing arms 110, or other header 108 suspension components also may comprise one or more sensors (not shown) for determining the position of the mounting points 202, swing arms 110, or other suspension components mounting the header 108 to the chassis 102.

The positions of the actuators 112 and/or other header 108 suspension components are correlated to the positions of the header 108 and therefore serve as proxies for the positions of the header 108 relative to the chassis 102. Furthermore, because the position of the header 108 relative to the chassis 102 during operation of the vehicle 100 is dictated by the contour of the ground in contact with the header 108 as the vehicle 100 moves over the ground, the position data from the position sensors on the actuators 112 and/or other header 108 suspension components also correlate to the position of the ground in contact with the header 108 relative to the chassis 102. Alternative ways to obtain position data for the ground in contact with or in front of the header 108 include lidar on the header 108 or position-measuring gauge wheels in front of the header 108.

In step 502, using the data provided by the position sensors, control system 400 detects a change in the position of the header 108 relative to the chassis 102 caused by a change in a contour of the ground in contact with the header 108.

In step 504, the control system 400 calculates a velocity, an acceleration, and a change in the acceleration for the change in the position of the header 108 relative to the chassis 102. For example, in an embodiment where the position sensor is located on a hydraulic actuator 112 that controls the position of the header 108 relative to the chassis 102, velocity (v) of the piston movement is calculated as v=dy/dt, wherein y=position of cylinder piston, and t=time. The acceleration (a) of the piston movement is calculated as a=d²y/dt²; the acceleration of the piston movement is indicative of the slope of the ground in contact with the header 108 that caused the piston movement. Finally, the change in acceleration of the piston movement, which is indicative of a change in the ground slope, is calculated as d³y/dt³.

In step 506, if control system 400 calculates that the piston acceleration is zero and that the change in the piston acceleration is greater than or less than zero, a change in the slope of the ground contour is occurring. Thus, when the change in piston acceleration d³y/dt³ is a positive value and the piston acceleration d²y/dt² is equal to zero, this indicates that the header 108 is approaching a gully, and it becomes necessary to increase the float pressure in order to decrease the force of the header 108 against the ground. When the change in piston acceleration d³y/dt³ is a negative value and piston acceleration d²y/dt² is equal to zero, this indicates that the header 108 is approaching a crest of a hill, and it becomes necessary to decrease the float pressure in order to increase the force of the header 108 against the ground. If d3y/dt3=0, then there is no change in the ground slope, and the control loop returns to step 502.

In step 508, the control system 400 adjusts one or more operating parameters of the actuators 112 to maintain the desired ground reaction force. In one embodiment, control system 400 changes the hydraulic pressure on the rod end of the hydraulic cylinder that supports the weight of the header 108. A pressure-reducing valve and a pump in the vehicle hydraulic circuit operate to increase or decrease the floatation pressure, which has an inverse correlation to ground reaction force. The magnitude of pressure change is dependent on the difference between the 3rd derivative of piston position and 0, when acceleration is 0.

An increase in float pressure encourages upward motion of the header 108 relative to the chassis 102 when approaching the bottom of a gully, decreasing header 108 weight on the ground, anticipating the bottom of a depression in the field, decreasing header wear, and lessening accumulation of mud and other debris on the header 108. A decrease in float pressure encourages downward motion of the header 108 over the crest of the hill, increasing header weight on the ground, anticipating the crest of the hill, causing the header 108 to more closely follow the ground as the ground falls away, and cutting more crop.

It will be appreciated that the foregoing method may be modified in various ways, or replaced by a different control method. For example, the header control system 400 may be operated by setting a target maximum ground force, and controlling the actuators 112 to maintain the measured ground force below the maximum value. This may be helpful, for example, to avoid “bulldozing” the soil in certain ground conditions, and to prevent potentially damaging overloads. Such a control process may be added to the foregoing process, or used as a separate process. Other alternatives and variations will be apparent to persons of ordinary skill in the art in view of the present disclosure.

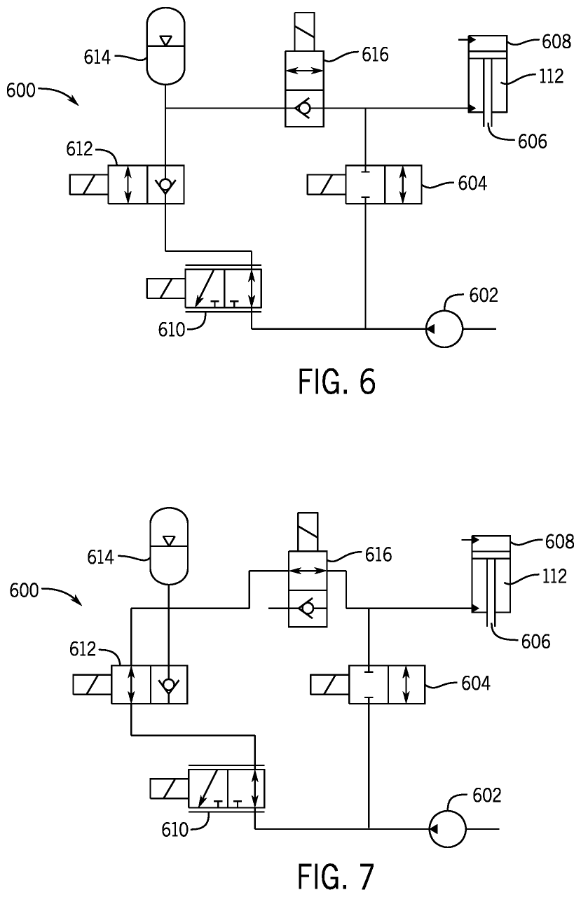

FIG. 6 illustrates an example of a hydraulic system 600 that may be used to control the header 108 system to achieve uniform ground reaction forces as described above. The hydraulic system 600 generally includes an actuator 112 that is controlled by a source of pressurized hydraulic fluid such as a hydraulic pump 602 and control valves.

In this example, a position control valve 604 is connected between the actuator 112 and the pump 602, and operable to increase or decrease the static volume of hydraulic fluid in the actuator 112 cylinder. In the open position, the pump 602 directs fluid into the actuator 112 to retract the actuator piston 606 into the cylinder 608. The actuator 112 is connected between the chassis 102 and the header 108 such that retracting the piston 606 raises the header 108. Thus, the position control valve 604 may be used to set the operating height of the header 108. When the operating height is set, the position control valve 604 is closed (such as shown). The position control valve 604 also may include additional positions to vent hydraulic fluid from the cylinder 608 or direct fluid to the other side of the piston 606, in order to lower the header 108, or other position control valve systems may be used to lower the header 108 (e.g., a separate bleed valve located between the position control valve 604 and the actuator 112, etc.).

The hydraulic system 600 also includes an adjustable float circuit comprising an adjustable pressure reducing valve 610, a first float valve 612, an accumulator 614, and a second float valve 616. The pressure reducing valve 610 is connected to the pump 602, and can be adjusted to vary the magnitude of output pressure that is directed from via the pressure reducing valve 610 to the downstream remainder of the float circuit. Any suitable pressure reducing valve, such as a solenoid-operated or other electrically-controlled valve, may be used as the pressure reducing valve 610, as known in the art.

The first float valve 612 is located downstream of the pressure reducing valve 610, and is movable between an open position (FIG. 7) in which hydraulic fluid passes unimpeded in either direction, and a one-way position (FIG. 6) in which fluid can only pass downstream through the first float valve 612. Similarly, the second float valve 616 is located downstream of the first float valve 612, and configurable between an open position (FIG. 7) in which hydraulic fluid passes unimpeded in either direction, and a one-way position (FIG. 6) in which fluid can only pass downstream through the second float valve 616. The accumulator 614 is located in the hydraulic circuit joining the first float valve 612 to the second float valve 616. The accumulator 614 may comprise any suitable accumulator mechanism, such as a conventional adjustable gas-over-fluid accumulator having a sealed gas bladder located inside a hydraulic chamber.

The float circuit is operable to selectively connect the actuator 112 to pressurized hydraulic fluid to generate a force to bias the actuator 112 towards the retracted (i.e., lifted) position. In the position shown in FIG. 6, the first float valve 612 and second float valve 616 allow pressurized fluid to pass from the pump 602 to the actuator 112 to raise the header 108. However, reverse flow is not possible. Thus, external forces that raise the header 108 can pull hydraulic fluid from the pump 602 and/or accumulator 614 through the float valves 612, 616 into the actuator cylinder 608, but absent the opening of a separate vent the actuator 112 and header 108 cannot lower.

Moving the second float valve 616 to the open position allows reverse flow, and thus connects the actuator cylinder 608 to the accumulator 614. Thus, with the second float valve 616 open (as shown in FIG. 7), and the first float valve 612 closed (as in FIG. 6), the actuator 112 and header 108 can move up and down by compressing or expanding the gas in the accumulator 614. However, if the pressure of this circuit drops below the input pressure of the pump 602 (as limited by the pressure reducing valve 610), more hydraulic fluid will pass through the first float valve to increase fluid volume in the accumulator 614 and/or actuator cylinder 608.

FIG. 7 shows the hydraulic circuit 600 with the first float valve 612 and the second float valve 616 in their respective open positions, to allow two-way flow through both valves. This configuration may be used temporarily to change the charge pressure of the accumulator 614, to thereby adjust the reaction load on the header 108 (e.g., increasing pressure in the accumulator 614 to reduce reaction forces, and vice versa).

The valve configuration in FIG. 7 also can be used continuously, to use the pressure reducing valve 610 to directly control the reaction forces at the actuator 112 in real time by continuously adjusting the output pressure of the pressure reducing valve 610. Specifically, pressurized fluid from the pump 602 is continuously connected to the actuator cylinder 608, and the pressure of this fluid generates a force that biases to the piston 606 towards the retracted position, and creates and upwards force at the header 108 to reduce the ground reaction force. The magnitude of this force is controlled by the pressure reducing valve 610. The output pressure of the pressure reducing valve 610 is controlled by a control system 400 that uses force feedback at the header 108, such as described above in relation to FIG. 5, by modulating the magnitude of current applied to the pressure reducing valve 610. Thus, the pressure reducing valve 610 and hydraulic circuit 600 can be operated to provide a continuous or nearly continuous ground reaction force at the header 108 by adjusting the operating pressure of the actuator 112.

The exemplary hydraulic circuit 600 may be modified in various ways. For example, the hydraulic circuit 600, or one or more elements thereof, may be duplicated to provide separate control to a second actuator 112 (e.g., a separate actuator 112 operated by a separate float circuit but using a common pump 602 and hydraulic reservoir). Alternatively, a plurality of actuators 112 may be operatively driven by a single hydraulic circuit. Other alternatives and variations will be apparent to persons of ordinary skill in the art in view of the present disclosure.

It will also be appreciated that the foregoing systems and methods for controlling a header using measured ground reaction force may be applied to different types of headers or other equipment. Thus, the terms “header” and “frame” are used generically to refer to a part (the header) that is movably attached to another part (the frame). In the foregoing embodiment, the header 108 is attached to the chassis 102 of the vehicle 100 (i.e., the vehicle frame), but in the example of FIG. 8 the header 108 is a portion of a header that is movably attached to another portion of the header. For example, FIG. 8 illustrates a segmented or “winged” header having a center section 800 and two wing sections 802. Each wing section 802 may include one or more support members 206. Each wing section 802 also has an actuator 112 that is configured to raise the wing section 802 relative to the center section 800. The actuators 112 are separately or collectively controlled, such as described above, to maintain the ground reaction forces at the support members 206 at a continuous or nearly continuous value. In this example, each wing section 802 is a header, and the frame is the center section 800.

As another example, FIG. 9 illustrates a header subframe 108a that is attached to the header main frame 108b by a movable connection, such as a pivot 900. The subframe 108a may include various components, such as a cutterbar 902, draper belts 904, and skid shoes 206. One or more hydraulic actuators 112a connect the subframe 108a to the main frame 108b. In this case, the header subframe 108a is controlled, such as described above, to regulate the force of the subframe 108a on the ground. The header main frame 108b also may be movable relative to the chassis 102, such as by being attached to the chassis 102 by a movable feeder housing 906, as known in the art. This movable joint also may be operated by actuators 112b using a conventional control system, or a system as described herein to provide layered force control (e.g., one control to regulate force between the main frame 108b and the ground, and another control to regulate force between the subframe 108a and the ground). Other alternatives and variations will be apparent to persons of ordinary skill in the art in view of the present disclosure.

The present disclosure describes a number of inventive features and/or combinations of features that may be used alone or in combination with each other or in combination with other technologies. The embodiments described herein are all exemplary and are not intended to limit the scope of the claims. It will also be appreciated that the inventions described herein can be modified and adapted in various ways, and all such modifications and adaptations are intended to be included in the scope of this disclosure and the appended claims.

What is claimed:

1. A method of operating a header float control system of an agricultural vehicle having a header movably mounted to a chassis by an actuator, the method comprising:
setting a desired ground reaction force between the header and a ground surface located below the header, wherein the header is in contact with the ground surface;
detecting a change in a position of the header relative to the chassis caused by a change in a contour of the ground in contact with the header;
calculating a velocity, an acceleration, and a change in the acceleration for the change in the position of the header relative to the chassis; and
wherein upon calculating that the acceleration is zero and the change in the acceleration is greater than zero, or wherein upon calculating that the acceleration is zero and the change in the acceleration is less than zero, adjusting a lift pressure of the actuator in proportion to the change in the acceleration for the position change of the header relative to the chassis to maintain the desired ground reaction force.

2. The method of claim 1, wherein setting the desired ground reaction force comprises receiving a selection of an adjustable value for the desired ground reaction force.

3. The method of claim 1, wherein detecting the change in the position of the header relative to the chassis comprises detecting a change in the position of the actuator.

4. The method of claim 1, wherein the actuator comprises a hydraulic actuator, and adjusting a lift pressure of the actuator in proportion to the change in the acceleration for the position change of the header relative to the chassis to maintain the desired ground reaction force comprises adjusting an operating pressure of the hydraulic actuator.

5. The method of claim 1, wherein adjusting the operating pressure of the hydraulic actuator comprises changing an output pressure of a pressure reducing valve operatively connected to the hydraulic actuator.

6. The method of claim 1, wherein upon calculating that the acceleration is zero and the change in the acceleration is greater than zero, the operating pressure of the hydraulic actuator is increased to maintain the desired ground reaction force.

7. The method of claim 1, wherein upon calculating that the acceleration is zero and the change in the acceleration is less than zero, the operating pressure of the hydraulic actuator is decreased to maintain the desired ground reaction force.

8. The method of claim 1, wherein the velocity is calculated as a first derivative of the change in position of the header relative to the chassis, the acceleration is calculated as a second derivative of the change in position of the header relative to the chassis, and the change in acceleration is calculated as a third derivative of the change in position of the header relative to the chassis.

9. An agricultural vehicle comprising:
a chassis;
a header movably mounted to the chassis;
an actuator configured to move the header relative to the chassis; one or more support members extending between the header and a ground surface for contacting the ground surface; and
a control system operatively connected to the actuator and configured to:
set a ground reaction force between the header and a ground surface located below the header, wherein the header is in contact with the ground surface;
detect a change in a position of the header relative to the chassis caused by a change in a contour of the ground in contact with the header;
calculate a velocity, an acceleration, and a change in the acceleration associated with the change in the position of the header relative to the chassis;
wherein upon calculating that the acceleration is zero and the change in the acceleration is greater than zero, or wherein upon calculating that the acceleration is zero and the change in the acceleration is less than zero, adjust a lift pressure of the actuator in proportion to the change in acceleration for the position change of the header relative to the chassis to maintain the desired ground reaction force.

10. The agricultural vehicle of claim 9, wherein the control system comprises a user interface configured to receive a selection of an adjustable value for the desired ground reaction force.

11. The agricultural vehicle of claim 9, wherein the actuator comprises a hydraulic actuator, and the control system is configured to operate the hydraulic actuator to maintain the desired ground reaction force by adjusting an operating pressure of the hydraulic actuator.

12. The agricultural vehicle of claim 9, wherein the control system is operatively connected to a pressure reducing valve that is configured to adjust the operating pressure of the hydraulic actuator.

13. The agricultural vehicle of claim 9, wherein the one or more support members each comprise a skid shoe pivotally mounted to the header.
